(19) United States
(12) Patent Application Publication
(10) Pub. No.: US 2026/0356664 A1
(43) Pub. Date: Nov. 12, 2026

(54) SYSTEM AND PROCESS FOR CRACKING AMMONIA

(71) Applicant: Johnson Matthey Davy Technologies Limited, London (GB)

(72) Inventors: John David PACH, Billingham (GB); Kate MCFARLANE, Stockton-On-Tees (GB); Julie Louise ASHCROFT, Royston (GB)

(21) Appl. No.: 19/483,875

(22) PCT Filed: Jul. 11, 2024
(86) PCT No.: PCT/GB2024/051806

§ 371 Date: Nov. 12, 2025

(30) Foreign Application Priority Data
Jul. 12, 2023 (GB) 2310668.5

(51) Int. Cl. C01B 3/047

(52) U.S. Cl. CPC C01B 3/047; C01B 2203/0277; C01B 2203/04; C01B 2203/085; C01B 2203/1205

(57) ABSTRACT

A system for the catalytic cracking of ammonia to produce hydrogen, the system comprising: a main ammonia cracking reactor comprising one or more reaction tubes containing ammonia cracking catalyst and a fuel combustion zone surrounding the one or more reaction tubes to provide heat energy to support the cracking of ammonia in the one or more reaction tubes to generate a main hydrogen containing gas stream; and an auxiliary ammonia cracking reactor for cracking ammonia to generate an auxiliary hydrogen containing gas stream, the system being configured to direct the auxiliary hydrogen containing gas stream to both the ammonia cracking catalyst within the one or more reaction tubes of the main ammonia cracking reactor and to the combustion zone of the main ammonia cracking reactor to at least partially fuel the main ammonia cracking reactor.

### FIELD

The present specification relates to a system and process for producing hydrogen gas by catalytically cracking ammonia.

### BACKGROUND

There is renewed interest in using hydrogen as a green, carbon free, fuel in a variety of industrial settings. Hydrogen may be combusted to produce heat energy or electricity. Alternatively, hydrogen may be used to produce electrochemical energy in, for example, a fuel cell.

Ammonia has received interest as a possible compound to enable the storage and transport of hydrogen. Liquid ammonia has a higher hydrogen density than liquid hydrogen and may be transported using existing infrastructure which is already in use for this purpose, such as that used for the transportation of ammonia in the agrochemical fertiliser industry. Once the liquid ammonia has been transported it may be combusted directly or converted to hydrogen by the process of cracking.

The catalytic cracking of ammonia into hydrogen and nitrogen has been known for many years. The reaction may be depicted as follows:

2NH₃ [symbol] N₂+3H₂

The ammonia cracking reaction is endothermic and may usefully be achieved by passing ammonia over a suitable catalyst in heated catalyst-containing reaction tubes disposed in a furnace. Such furnaces are known, for example, for the steam reforming of natural gas or naphtha feedstocks. In industrial processes used for the catalytic cracking of ammonia, the gas produced by the ammonia cracking reaction is purified to produce a purified hydrogen stream and a waste gas stream.

There remains a need for improved processes for the catalytic cracking of ammonia.

### SUMMARY

One issue to consider is how to most effectively fuel the furnace to support the endothermic ammonia cracking reaction. One option is to use a proportion of the produced hydrogen to at least partially fuel the furnace. Alternatively, or additionally, a waste gas stream from the ammonia cracking system, which comprises residual hydrogen, residual ammonia, and nitrogen, may be used to at least partially fuel the furnace. However, neither of these fuel sources are available at start-up of the ammonia cracking system.

Another issue to consider is that the ammonia cracking catalyst tends to be in an oxidized form at start-up of the ammonia cracking system and is thus inefficient at driving the cracking reaction, at least in an initial period of operation.

Yet another issue to consider is that the heated catalyst-containing reaction tubes disposed in the furnace may react with the ammonia containing gas forming an unwanted metal nitride layer. This unwanted side reaction, known as nitriding, may cause the accelerated failure of the reaction tubes.

Yet another issue to consider is the efficiency of the ammonia cracking reactor in converting a high partial pressure ammonia gas stream into hydrogen.

The present specification seeks to address these problems by providing a system for the catalytic cracking of ammonia to produce hydrogen, the system comprising:
a main ammonia cracking reactor comprising one or more reaction tubes containing ammonia cracking catalyst and a fuel combustion zone surrounding the one or more reaction tubes to provide heat energy to support the cracking of ammonia in the one or more reaction tubes to generate a main hydrogen containing gas stream; and
an auxiliary ammonia cracking reactor for cracking ammonia to generate an auxiliary hydrogen containing gas stream,
the system being configured to direct the auxiliary hydrogen containing gas stream to both the ammonia cracking catalyst within the one or more reaction tubes of the main ammonia cracking reactor and to the combustion zone of the main ammonia cracking reactor to at least partially fuel the main ammonia cracking reactor

The present specification also provides a process for operating the system. A feature of the system and process is the auxiliary ammonia cracking reactor which generates a hydrogen containing gas stream, the system directing this hydrogen containing gas stream to both the ammonia cracking catalyst within the reaction tubes of the main ammonia cracking reactor and also to the combustion zone of the main ammonia cracking reactor to fuel the reactor. Such a configuration enables the auxiliary ammonia cracking reactor to address one, more, or all of the aforementioned problems as follows:
(i) The auxiliary ammonia cracking reactor can generate and direct a hydrogen containing gas stream to the ammonia cracking catalyst within the reaction tubes of the main ammonia cracking reactor following installation to reduce oxidic ammonia cracking catalyst and thus ensure that the catalyst will efficiently drive the cracking reaction from start-up of the main ammonia cracking reactor.
(ii) The auxiliary ammonia cracking reactor can also generate and direct a hydrogen containing gas stream to the combustion zone of the main ammonia cracking reactor to at least partially fuel the main ammonia cracking reactor, particularly at start-up of the main ammonia cracking reactor prior to the main reactor generating hydrogen and waste gases (e.g., from a purification unit) which themselves may be used independently or in combination to at least partially fuel the main reactor.
(iii) The auxiliary ammonia cracking reactor can generate and direct a hydrogen containing gas stream through the reaction tubes of the main ammonia cracking reactor during operating to reduce the partial pressure of ammonia in the reaction tubes and thus reduce the rate of nitriding of the reaction tubes.
(iv) As at least some of the ammonia is cracked by the auxiliary ammonia cracking reactor, the main ammonia cracking reactor can be configured to use less fuel (e.g., by enabling a smaller main reactor to be used which requires less fuel) thus improving the efficiency of the system and reducing capital and/or operating costs.
(v) As the auxiliary ammonia cracking reactor is configured to be able to direct a hydrogen containing gas stream to both the ammonia cracking catalyst within the reaction tubes of the main ammonia cracking reactor and also to the combustion zone of the main ammonia cracking reactor to fuel the reactor, this configuration provides a system which has a much greater degree of flexibility for controlling both the reaction gases and the fuel gases, both at start-up and during extended operation of the ammonia cracking system to enhance the efficiency, safety, and lifetime of the system.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a schematic diagram of a system for cracking ammonia;

FIG. 2 shows a schematic diagram of another system for cracking ammonia; and

FIG. 3 shows a schematic diagram of another system for cracking ammonia.

In all figures, like reference numerals are used for like parts. A list of the references is provided below:

| Reference | Item |
|---|---|
| 2 | Ammonia Cracking System |
| 4 | Main Ammonia Cracking Reactor |
| 6 | Reactor Tube(s) in Main Ammonia Cracking Reactor |
| 8 | Ammonia Cracking Catalyst in Reactor Tubes |
| 10 | Fuel Combustion Zone of Main Ammonia Cracking Reactor |
| 11 | Hydrogen Containing Gas Stream from Main Ammonia |
| | Cracking Reactor |
| 12 | Auxiliary Ammonia Cracking Reactor |
| 14 | Ammonia Gas Input Stream |
| 16 | Auxiliary Hydrogen Containing Gas Stream (AHCGS) |
| 18 | Portion of AHCGS to Ammonia Cracking Catalyst of |
| | Main Reactor |
| 20 | Portion of AHCGS to Combustion Zone of Main Reactor |
| 21 | First Ammonia Cracking Pathway |
| 22 | Second Ammonia Cracking Pathway |
| 24 | Purification Unit |
| 26 | Purified Hydrogen Gas Stream |
| 28 | Tail Gas (waste gas stream) to Combustion Zone of |
| | Main Ammonia Cracking Reactor |

### DETAILED DESCRIPTION

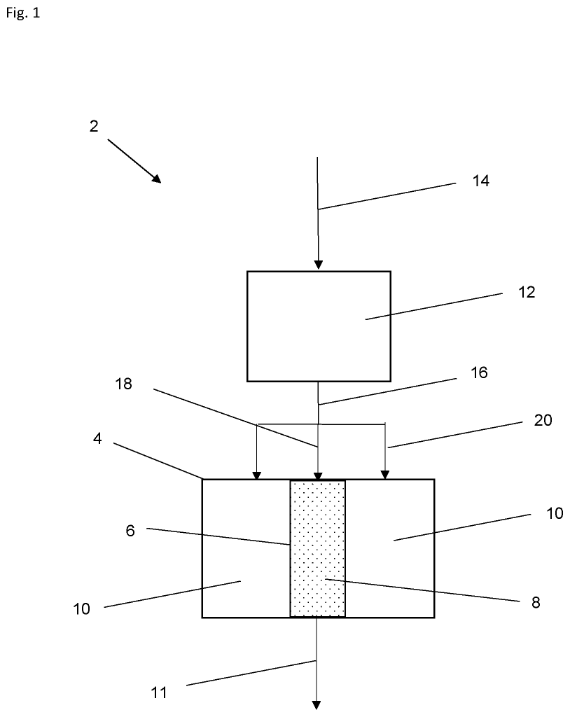

As described in the summary section and as illustrated in FIG. 1, the present specification provides a system 2 for the catalytic cracking of ammonia to produce hydrogen. The system 2 comprises a main ammonia cracking reactor 4 comprising one or more reaction tubes 6 containing ammonia cracking catalyst 8 and a fuel combustion zone 10 surrounding the one or more reaction tubes 6 to provide heat energy to support the cracking of ammonia in the one or more reaction tubes 6 to generate a main hydrogen containing gas stream 11. The system 2 further comprises an auxiliary ammonia cracking reactor 12 for cracking ammonia to generate an auxiliary hydrogen containing gas stream 16.

The system 2 is configured to direct at least a portion 18 of the auxiliary hydrogen containing gas stream 16 to the ammonia cracking catalyst 8 within the one or more reaction tubes 6 of the main ammonia cracking reactor 4 and at least a portion 20 of the auxiliary hydrogen containing gas stream 16 to the combustion zone 10 of the main ammonia cracking reactor 4 to at least partially fuel the main ammonia cracking reactor 4.

The process for cracking ammonia using the system thus comprises feeding an ammonia gas input stream 14 to the auxiliary ammonia cracking reactor 12 to crack the ammonia gas input stream and generate an auxiliary hydrogen containing gas stream 16. A portion 18 of the auxiliary hydrogen containing gas stream is fed to the ammonia cracking catalyst 8 within the one or more reaction tubes 6 of the main ammonia cracking reactor 4. Furthermore, a portion 20 of the auxiliary hydrogen containing gas stream is fed to the combustion zone 10 of the main ammonia cracking reactor 4 to at least partially fuel the main ammonia cracking reactor 4.

The auxiliary ammonia cracking reactor is optionally heated electrically and/or uses an electrical heater on the gas inlet of the reactor. As such, the auxiliary ammonia cracking reactor can be used to generate a cracked gas (H₂/N₂) independently of the rest of the ammonia cracking plant. The auxiliary ammonia cracking reactor can be used to generate a fuel that can be combusted in the main fired ammonia cracking reactor during start-up, and also can be used to reduce oxidic ammonia cracking catalyst in the main reactor following installation. The auxiliary ammonia cracking reactor provides a hydrogen source without requiring the wider plant to be operating, giving benefits related to start-up

The system can be configured to vary how much of the auxiliary hydrogen containing gas stream is directed to the ammonia cracking catalyst within the one or more reaction tubes of the main ammonia cracking reactor and how much of the auxiliary hydrogen containing gas stream is directed to the combustion zone of the main ammonia cracking reactor to at least partially fuel the main ammonia cracking reactor. For example, the system can switch between providing all of the auxiliary hydrogen containing gas stream to the ammonia cracking catalyst, providing all of the auxiliary hydrogen containing gas stream to the combustion zone, or split the auxiliary hydrogen containing gas stream to direct a proportion to the ammonia cracking catalyst and a proportion to the combustion zone as required at any time during start-up and extended operation of the system. This configuration provides a system which has a much greater degree of flexibility for controlling both the reaction gases and the fuel gases, both at start-up and during extended operation of the ammonia cracking system to enhance the operability, efficiency, safety, and lifetime of the system.

In terms of start-up, the ammonia cracking catalyst may be installed within the one or more reaction tubes of the main ammonia cracking reactor in oxidic form and, after installation when starting up the system, at least a portion of the auxiliary hydrogen containing gas stream is fed to the oxidic ammonia cracking catalyst to reduce oxidic ammonia cracking catalyst. Furthermore, at least a portion of the auxiliary hydrogen containing gas stream can be fed to the combustion zone of the main ammonia cracking reactor to at least partially fuel the main ammonia cracking reactor to start-up the main ammonia cracking reactor.

The addition of a secondary/auxiliary ammonia cracking reactor, either upstream of a fired ammonia cracker reactor, or in parallel to a fired ammonia cracking reactor, thus provides a good solution to starting up the ammonia cracking plant. The auxiliary ammonia cracking reactor can be an adiabatic bed, with or without an electrical heater upstream, or can be an electrically heated reactor. Alternatively, energy can be provided to the auxiliary reactor through other means, including combustion of an alternative gas.

Ammonia cracking catalysts are likely to be provided in oxidic form and require reduction with hydrogen or a hydrogen containing stream to activate the catalyst when the plant is being commissioned or following a replacement of catalyst. Ammonia can be used as a reductant but must undergo decomposition to hydrogen first. Experimental work indicates that catalyst reduced purely under ammonia exhibits lower activity than catalyst reduced under hydrogen. At low temperatures, there is not expected to be a significant decomposition of ammonia. As a result, the catalyst at the top of the fired cracker tubes may not be fully reduced. This can be overcome by using an auxiliary (e.g., adiabatic) ammonia cracking reactor to generate a cracked gas stream. The cracked gas, which may still contain high levels of ammonia, can be fed into the fired cracker and the hydrogen within the gas used to reduce the catalyst from oxidic form to active metal.

For start-up at any time, the auxiliary cracking reactor can also be used to generate hydrogen/cracked gas to light off the burners of the main reactor. At start-up, only ammonia may be available as a fuel. However, experimental work has shown that the burners in a fired ammonia cracker reactor will not light off (i.e., a flame will not be formed) when using 100% ammonia fuel. Examples of fuel compositions which have been found to light off successfully include:
cracked gas (75% H₂, 25% N₂, residual ammonia)
80% NH₃ and 20% H₂.

It has also been found experimentally that following successful light off, the hydrogen content from the fuel can be removed and the flame will continue to burn on a 100% NH₃ fuel.

A secondary/auxiliary ammonia cracking reactor can therefore be used to generate cracked gas which can be directly used as a start-up fuel, or to generate cracked gas which is then separated to produce hydrogen which can be blended with ammonia to be used as a start-up fuel. The fuel can also be used to heat a gas circulating the plant, e.g., ammonia or nitrogen, allowing the plant to be brought to the required/optimized temperatures prior to commencement of the ammonia cracking reaction and hydrogen production.

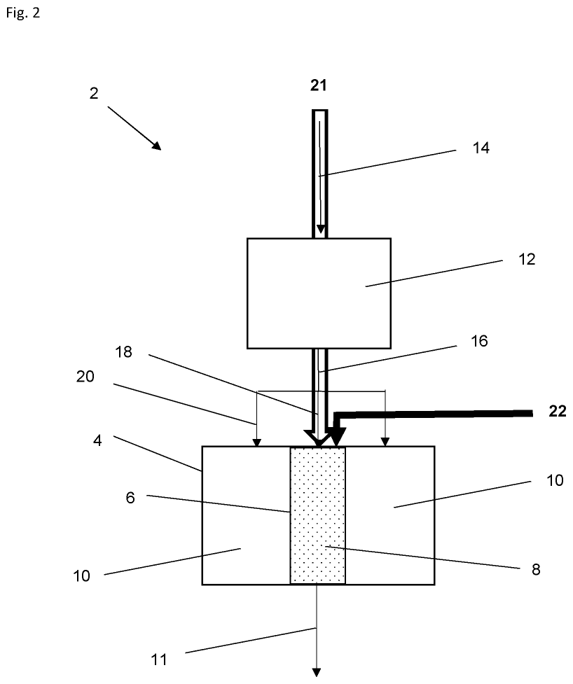

As illustrated in FIG. 2, the system may comprise or consist of a first ammonia cracking pathway 21 in which an ammonia gas input stream 14 is first passed through the auxiliary ammonia cracking reactor 12 to generate an auxiliary hydrogen containing gas stream 16 which is then passed through the one or more reaction tubes of the main ammonia cracking reactor 4 to generate the main hydrogen containing gas stream. Additionally, as shown in FIG. 2, the system may comprise a second ammonia cracking pathway 22 in which an ammonia gas input stream is passed through the one or more reaction tubes 6 of the main ammonia cracking reactor 4 without first passing through the auxiliary ammonia cracking reactor 12. Accordingly, during operation of the main ammonia cracking reactor 4, input gas to the ammonia cracking catalyst 8 within the one or more reaction tubes 6 may comprise a fresh (uncracked) ammonia gas input stream 22, an at least partially cracked ammonia gas input stream 16 (the auxiliary hydrogen containing gas stream) from the auxiliary ammonia cracking reactor, or a combination of a fresh (uncracked) ammonia gas input stream 22 and the auxiliary hydrogen containing gas stream 16. Alternatively, during operation of the main ammonia cracking reactor, input gas to the ammonia cracking catalyst within the one or more reaction tubes may consist of only the auxiliary hydrogen containing gas stream.

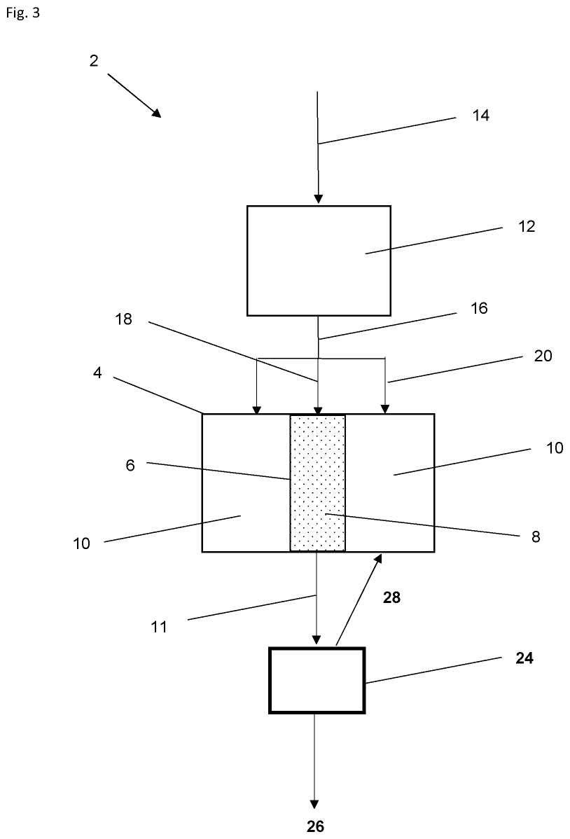

As shown in FIG. 3, the system may further comprise at least one purification unit 24 to increase the hydrogen content of the main hydrogen containing gas stream to produce a purified hydrogen gas stream 26. Furthermore, the system may comprise at least one purification unit (not shown in FIG. 3) to increase the hydrogen content of the auxiliary hydrogen containing gas stream 16. The same or different purification units may be provided to increase the hydrogen content of the main hydrogen containing gas stream and the auxiliary hydrogen containing gas stream. Furthermore, the system may be configured to direct a tail gas or waste gas 28 from at least one of the purification units 24 to the combustion zone 10 of the main ammonia cracking reactor 4 to at least partially fuel the main ammonia cracking reactor. In this regard, it may be noted that fuel gas for combustion to heat the main reactor can be composed of one or more of: fresh (uncracked) ammonia; the auxiliary hydrogen containing gas stream from the auxiliary reactor; purified hydrogen from the one or more purification units; waste/tail gas from the one or more purification units; or an external fuel gas (e.g., methane) source.

While the systems as described above are particularly useful for commissioning and start-up of an ammonia cracking plant, the configurations are also advantageous for on-going operation of the plant. After start-up of the main ammonia cracking reactor, at least a portion of the auxiliary hydrogen containing gas stream can continue to be fed (continuously or intermittently) to the combustion zone of the main ammonia cracking reactor to at least partially fuel the main ammonia cracking reactor during operation. Furthermore, after start-up of the main ammonia cracking reactor, at least a portion of the auxiliary hydrogen containing gas stream can continue to be fed (continuously or intermittently) to the ammonia cracking catalyst within the one or more reaction tubes of the main ammonia cracking reactor to reduce the partial pressure of ammonia in the one or more reaction tubes and thus reduce the rate of nitriding of the one or more reaction tubes. This configuration thus provides a system which has a much greater degree of flexibility for controlling both the reaction gases and the fuel gases, both at start-up and during extended operation of the ammonia cracking system to enhance the operability, efficiency, safety, and lifetime of the system. In this regard, the auxiliary ammonia cracking reactor can be controlled in order to control the composition of the auxiliary hydrogen containing gas stream and consequent compositions of reaction gas and fuel gas as desired for optimal performance at start-up and during operation. For example, the auxiliary ammonia cracking reactor may be controlled such that the auxiliary hydrogen containing gas stream comprises: at least 10 mol %, 20 mol %, 30 mol %, 40 mol %, 50 mol %, or 60 mol % of H₂; no more than 100 mol %, 90 mol %, 80 mol %, or 70 mol % of H₂; or a H₂ content within a range defined by any combination of the aforementioned lower and upper limits.

In relation to the above, it has been noted that WO2022189560 discusses pre-cracking an ammonia gas stream and then passing the partially cracked gas stream to a reactor for further cracking. It has also been noted that US20220403775 discusses an ammonia processing system comprising more than one reactor modules configured to generate hydrogen from a source material comprising ammonia and that the hydrogen generated by one of the reactor modules may be used to provide additional heating of the other reactor modules via combustion of the hydrogen. However, neither document discloses or suggests a system which is configured to both reduce oxidic catalyst in the main reactor and fuel the main reactor, e.g., for start-up of the system or optimization of both reaction and fuel gas mixtures.

Suitable fired ammonia cracking reactors for the main reactor of the present system are known and may comprise a fuel combustion zone having a radiant section comprising one or more burners to which one or more fuel streams and an oxygen feed gas, such as air, oxygen enriched air, or oxygen, are fed. The radiant section may comprise the one or more catalyst containing reaction tubes though which the ammonia stream is passed. Combustion of one or more fuel streams in the one or more burners of the fuel combustion zone, creates heat energy (e.g., radiant heat) for heating the one or more catalyst containing reaction tubes. There may be tens or hundreds of catalyst containing reaction tubes in the radiant section. If desired, downstream of the radiant section, a flue gas from the combustion of the one or more fuel streams may be used to pre-heat one or more feed streams in a convection section. Reactors comprising a radiant section containing catalyst containing reaction tubes and a convection section for preheating feeds are known in steam methane reforming and may be applied to the present invention.

Alternatively, fired ammonia cracking reactors may be used where the combustion of the one or more fuel streams in a fuel combustion zone is separate to the reactor comprising the catalyst containing reaction tubes. Such a reactor is the compact reformer available from Johnson Matthey Davy Technologies Limited.

The catalyst in the catalyst containing reaction tubes may be any ammonia cracking catalyst. For instance, nickel catalysts and/or ruthenium catalysts may be used. Preferred catalysts are nickel catalysts. The catalyst may comprise 3 to 30% by weight nickel, preferably 8 to 20% by weight nickel, expressed as NiO, on a suitable refractory support, such as alumina or a metal aluminate. The catalyst may be in the form of pelleted shaped units, which may comprise one or more through holes, or may be provided as a wash coat on a structured metal or ceramic catalyst. A particularly preferred catalyst is KATALCO™ 27-2 available from Johnson Matthey PLC, which comprises 12% nickel, expressed as NiO, on a cylindrical pellet formed from a high surface area calcium aluminate support. Another preferred catalyst is KATALCO™ 27-200MQ available from Johnson Matthey PLC, which comprises 14% nickel, expressed as NiO.

The type of reactor which may be used for the auxiliary ammonia cracking reactor is not particularly limited. Furthermore, more than one auxiliary ammonia cracking reactor may be provided. The one or more auxiliary ammonia cracking reactors may be an adiabatic reactor, a packed bed reactor, an electrically heated reactor, and/or a gas fired reactor. Preferably, the one or more secondary ammonia reactors are adiabatic or electrically heated reactors, such as an adiabatic packed bed reactor. Adiabatic reactors include reactors where no heat is transferred from the reactor to the ammonia stream being fed to it. For example, an adiabatic reactor does not include a reactor which provides heat energy to the ammonia stream.

The heat energy required to support the cracking reaction in the one or more auxiliary ammonia cracking reactors may be provided by heating the input ammonia stream and/or by providing an auxiliary ammonia cracking reactor which provides heat energy. The heat energy may be provided from a source external to the process (e.g., imported electricity).

The one or more auxiliary ammonia cracking reactors comprise a catalyst. The catalyst may be any catalyst for the cracking of ammonia. The catalyst may suitably be any one of those described above as being suitable for use with the main fired ammonia cracking reactor.

The input ammonia stream may be heated prior to being supplied to the auxiliary ammonia cracking reactor and/or the main fired ammonia cracking reactor. Accordingly, the process of the invention may comprise the step of heating the input ammonia stream. The input ammonia stream may be heated to a temperature of greater than 350 °C, greater than 400 °C, greater than 450 °C, greater than 500 °C, or greater than 550 °C. The input ammonia stream may be heated to a temperature of less than 1000 °C, less than 950 °C, less than 850 °C, less than 750 °C, or less than 700 °C. The input ammonia stream may be heated to a temperature of from 350 °C to 1000 °C, from 400 °C to 950 °C, from 450 °C to 850 °C, or from 500 °C to 750 °C, such as from 550 °C to 700 °C.

The temperature of the ammonia stream at the inlet to the one or more catalyst containing reaction tubes may be in the range of 350 °C to 1000 °C, from 400 °C to 950 °C, from 450 °C to 850 °C, or from 500 °C to 750 °C, such as from 550 °C to 700 °C. The temperature of the hydrogen containing stream exiting the one or more catalyst containing reaction tubes will influence the equilibrium position of the cracking reaction, and may be in the range of 500 to 950 °C. Where nickel catalysts are used in the one or more catalyst containing reaction tubes, the temperature of the hydrogen containing stream exiting the one or more catalyst containing reaction tubes may preferably be greater than about 700 °C.

The pressure inlet to the one or more catalyst containing reaction tubes will be set by the flowsheet design and may be in the range 1 to 100 bar absolute, preferably 10 to 90 bar absolute, such as 31 to 51 bar absolute.

The auxiliary ammonia cracking reactor may use a nickel containing catalyst, such as Katalco 27-2. In that case, the ammonia stream input to the auxiliary reactor may be heated to a temperature of from 700 °C to 1000 °C, from 750 °C to 900 °C, from 800 °C to 850 °C. Alternatively, the auxiliary ammonia cracking reactor may use a noble metal catalyst (e.g., a ruthenium based catalyst), such as Katalco 27-612. In that case, the ammonia stream input to the auxiliary reactor may be heated to a temperature of from 400 °C to 650 °C, from 450 °C to 650 °C, from 500 °C to 600 °C, or from 525 °C to 575 °C (e.g., about 550 °C).

The hydrogen containing stream from the main reactor, and optionally the auxiliary reactor, can be fed to one or more purification units to increase the hydrogen content of the hydrogen containing stream to produce an enriched hydrogen stream and a tail gas stream. An example of a purification unit is a pressure swing absorption unit, to increase the H₂ content by separating H₂ from the other components. The tail gas stream can be recycled and combusted as fuel in the combustion zone of the main reactor.

It may be preferred that prior to feeding the main hydrogen containing stream and/or the auxiliary hydrogen containing stream to the one or more purification units that the hydrogen containing streams are fed to a steam generation unit and/or a heat recovery zone. As will be understood by the skilled person the steam generation unit and/or the heat recovery zone may be used to recover low or medium grade heat.

It may be preferred that the main hydrogen containing stream and/or the auxiliary hydrogen containing stream comprise an equilibrium mixture of hydrogen, nitrogen, and ammonia.

The enriched hydrogen stream after purification may comprise 70 mol % or more H₂, 75 mol % or more H₂, 80 mol % or more H₂, 85 mol % H₂ or more, or 90 mol % H₂ or more. The enriched hydrogen stream may comprise up to 100 mol % or less H₂. For example, the enriched hydrogen stream may comprise from 70 mol % to 100 mol % H₂, from 75 mol % to 100 mol % H₂, from 80 mol % to 100 mol % H₂, from 85 mol % to 100 mol % H₂, or from 90 mol % to 100 mol % H₂. Preferably, the enriched hydrogen stream may comprise greater than 90 mol % H₂, greater than 95 mol % H₂, greater than 98 mol % H₂, or greater than 99 mol % H₂. More preferably, the enriched hydrogen stream may comprise greater than 99.9% mol % H₂, greater than 99.95 mol % H₂, or about 100 mol % H₂. Most preferably, the enriched hydrogen containing stream may comprise greater than 99.95 mol % H₂ or about 100 mol % H₂.

While this invention has been particularly shown and described with reference to certain examples, it will be understood to those skilled in the art that various changes in form and detail may be made without departing from the scope of the invention as defined by the appended claims.

1. A system for the catalytic cracking of ammonia to produce hydrogen, the system comprising:
a main ammonia cracking reactor comprising one or more reaction tubes containing ammonia cracking catalyst and a fuel combustion zone surrounding the one or more reaction tubes to provide heat energy to support the cracking of ammonia in the one or more reaction tubes to generate a main hydrogen containing gas stream; and
an auxiliary ammonia cracking reactor for cracking ammonia to generate an auxiliary hydrogen containing gas stream,
the system being configured to direct the auxiliary hydrogen containing gas stream to both the ammonia cracking catalyst within the one or more reaction tubes of the main ammonia cracking reactor and to the combustion zone of the main ammonia cracking reactor to at least partially fuel the main ammonia cracking reactor.

2. The system according to claim 1,
wherein the system comprises an electrical heater to support the cracking of ammonia to generate the auxiliary hydrogen containing gas stream.

3. The system according to claim 1,
wherein the system is configured to vary how much of the auxiliary hydrogen containing gas stream is directed to the ammonia cracking catalyst within the one or more reaction tubes of the main ammonia cracking reactor and how much of the auxiliary hydrogen containing gas stream is directed to the combustion zone of the main ammonia cracking reactor to at least partially fuel the main ammonia cracking reactor.

4. The system according to claim 1,
wherein the system comprises or consists of a first ammonia cracking pathway in which an ammonia gas input stream is first passed through the auxiliary ammonia cracking reactor to generate the auxiliary hydrogen containing gas stream which is then passed through the one or more reaction tubes of the main ammonia cracking reactor to generate the main hydrogen containing gas stream.

5. The system according to claim 4,
wherein the system comprises a second ammonia cracking pathway in which the ammonia gas input stream is passed through the one or more reaction tubes of the main ammonia cracking reactor without passing through the auxiliary ammonia cracking reactor.

6. The system according to claim 1,
comprising at least one purification unit to increase the hydrogen content of the main hydrogen containing gas stream.

7. The system according to claim 1,
comprising at least one purification unit to increase the hydrogen content of the auxiliary hydrogen containing gas stream.

8. The system according to claim 6,
wherein the system is configured to use the same purification unit to increase the hydrogen content of both the main hydrogen containing gas stream and the auxiliary hydrogen containing gas stream.

9. The system according to claim 6,
wherein the system is configured to direct a tail gas from at least one of the purification units to the combustion zone of the main ammonia cracking reactor to at least partially fuel the main ammonia cracking reactor.

10. A process for cracking ammonia using the system according to claim 1, the process comprising:
feeding an ammonia gas input stream to the auxiliary ammonia cracking reactor to crack the ammonia gas input stream and generate an auxiliary hydrogen containing gas stream;
feeding a portion of the auxiliary hydrogen containing gas stream to the ammonia cracking catalyst within the one or more reaction tubes of the main ammonia cracking reactor; and
feeding a portion of the auxiliary hydrogen containing gas stream to the combustion zone of the main ammonia cracking reactor to at least partially fuel the main ammonia cracking reactor.

11. The process according to claim 10,
wherein the ammonia cracking catalyst is installed within the one or more reaction tubes of the main ammonia cracking reactor in oxidic form and, after installation when starting up the system, at least a portion of the auxiliary hydrogen containing gas stream is fed to the oxidic ammonia cracking catalyst to reduce oxidic ammonia cracking catalyst.

12. The process according to claim 10,
wherein at least a portion of the auxiliary hydrogen containing gas stream is fed to the combustion zone of the main ammonia cracking reactor to at least partially fuel the main ammonia cracking reactor to start-up the main ammonia cracking reactor.

13. The process according to claim 10,
wherein after start-up of the main ammonia cracking reactor, at least a portion of the auxiliary hydrogen containing gas stream continues to be fed to the combustion zone of the main ammonia cracking reactor to at least partially fuel the main ammonia cracking reactor during operation.

14. The process according to claim 10,
wherein after start-up of the main ammonia cracking reactor, at least a portion of the auxiliary hydrogen containing gas stream continues to be fed to the ammonia cracking catalyst within the one or more reaction tubes of the main ammonia cracking reactor to reduce the partial pressure of ammonia in the one or more reaction tubes and thus reduce the rate of nitriding of the one or more reaction tubes.

15. The process according to claim 10,
wherein, during operation of the main ammonia cracking reactor, input gas to the ammonia cracking catalyst within the one or more reaction tubes comprises a combination of an ammonia gas input stream and the auxiliary hydrogen containing gas stream.

16. The process according to claim 10,
wherein, during operation of the main ammonia cracking reactor, input gas to the ammonia cracking catalyst within the one or more reaction tubes consists of the auxiliary hydrogen containing gas stream.

17. The process according to claim 10,
wherein the auxiliary ammonia cracking reactor is controlled such that the auxiliary hydrogen containing gas stream comprises: at least 10 mol %, 20 mol %, 30 mol %, 40 mol %, 50 mol %, or 60 mol % of H₂; no more than 100 mol %, 90 mol %, 80 mol %, or 70 mol % of H₂; or a H₂ content within a range defined by any combination of the aforementioned lower and upper limits.
